(19) United States
(12) Patent Application Publication
(10) Pub. No.: US 2016/0198649 A1
(43) Pub. Date: Jul. 14, 2016

(54) ROOT NUTRIENT DELIVERY SYSTEM AND EMITTER ASSEMBLY THEREFOR

(71) Applicant: David M. Allen, Howell, MI (US)

(72) Inventor: David M. Allen, Howell, MI (US)

(21) Appl. No.: 14/592,607

(22) Filed: Jan. 8, 2015

(51) Int. Cl. A01G 29/00

(52) U.S. Cl. CPC A01G 29/00

(57) ABSTRACT

A root nutrient delivery system comprising a housing, a plurality of emitter reinforcing ribs, an elongated slot and an mesh wall structure. The housing has a top panel and a depending wall portion. The depending wall portion defines an elongated tubular member to define a cavity. The top panel includes an emitter access opening extending therethrough and in communication with the cavity defined by the depending wall portion. The plurality of emitter reinforcing ribs extend to a location proximate a projection of the emitter opening into the cavity to define an inner support surface. The elongated slot is configured to receive an emitter hose. The mesh wall structure defines an elongated tubular member positioned over the depending wall portion of the housing. A emitter assembly is inserted through the elongated slot with an emitter being positioned within a projection of the emitter access.

### CROSS-REFERENCE TO RELATED APPLICATION

N/A

### BACKGROUND OF THE DISCLOSURE

1. Field of the Disclosure

The invention relates in general to watering devices and systems for irrigation, feeding and aeration of roots of plants, such as trees, bushes and shrubs, and more particularly, to a root nutrient delivery system and emitter assembly therefor.

2. Background Art

The use of nutrient delivery systems is known in the art. It is known that, due to compacted soil and similar conditions, absorbing oxygen, water and nutrients by a plant is difficult in urban environments. With such inhibited absorption, plants become more susceptible to disease and damage due to insects and the like.

Solutions have been developed in an effort to provide roots of plants with the necessary oxygen, water and nutrients. Some of these solutions involve the use of bubblers or other fluid emitting elements that are positioned in close proximity to plants. Such emitting elements are generally positioned or encased by structures which protect the emitter from damage and other inadvertent problems. While such emitters have provided some improvement, there are nevertheless drawbacks. In many instances, it is very difficult to replace, adjust or repair an emitter without digging up entire portions of dirt around the emitter and the plant. This can be very disruptive to the plant, as well as time consuming. Other drawbacks include the inability to maintain the emitter in the proper orientation relative to the plant, wherein the emitter becomes positioned in a less than optimal orientation, and often in an inoperable configuration. Other problems associated with the operation of the emitter persist, despite the improvements.

### SUMMARY OF THE DISCLOSURE

The disclosure is directed to a root nutrient delivery system comprising a housing, a plurality of emitter reinforcing ribs, an elongated slot and an mesh wall structure. The housing has a top panel and a depending wall portion. The top panel includes an upper surface and a lower surface. The depending wall portion defines an elongated tubular member extending from the lower surface to define a cavity. The top panel includes an emitter access opening extending therethrough and in communication with the cavity defined by the depending wall portion. The depending wall portion includes a proximal end proximate the top panel, and a distal end spaced apart therefrom. The plurality of emitter reinforcing ribs extend from at least one of an inner surface of the depending wall portion and the lower surface of the top panel to a location proximate a projection of the emitter opening into the cavity to define an inner support surface. The elongated slot in the depending wall portion extends from the distal end of the depending wall portion toward the proximal end. The elongated slot is configured to receive an emitter hose. The mesh wall structure defines an elongated tubular member overlyingly positioned over at least a portion of an outer surface of the depending wall portion of the housing. The mesh wall structure is slidably positioned over the distal end of the depending wall structure toward the proximal end of the depending wall structure. The mesh wall structure is overlyingly positionable over at least a portion of the elongated slot defined in the depending wall portion.

In such a configuration, an emitter assembly may be inserted into the cavity through the elongated slot and captured therewithin with an emitter being positioned within a projection of the emitter access opening, surrounded by the emitter reinforcing ribs. Such an emitter assembly including an emitter which is accessible through the emitter access opening.

In some configurations, the emitter of the emitter assembly is smaller than the emitter access opening, and substantially free from contact with the inner support surface of the emitter reinforcing ribs.

In some configurations, the emitter access opening further includes a depending wall portion directed into the cavity from the emitter access opening, with the inner support surfaces of the emitter reinforcing ribs extending therebelow.

In some configurations, the elongated slot further includes an entry end proximate the distal end of the depending wall portion, and an emitter retaining end opposite thereof. A pair of opposing locking fingers are positioned on either side of the elongated slot, and together with the emitter retaining end are configured to sandwich an emitter hose therebetween.

In some configurations, the locking fingers are elastically deformable by an emitter hose slid along the elongated slot from the entry end to the emitter retaining end, and beyond the locking fingers.

In some configurations, the mesh wall structure and the depending wall portion comprise substantially cylindrical members.

In some configurations, the mesh wall structure comprises a plurality of alternating vertical and horizontal members defining substantially square voids therebetween.

In some configurations, the system further includes a mesh coupling structure on the housing. The mesh coupling structure is configured to releasably retain the mesh wall structure relative to the housing.

In some configurations, the mesh coupling structure includes a plurality of nubs that extend from the outer surface of the depending wall portion. The nubs are configured to extend into a plurality of voids defined in the mesh wall structure, to preclude inadvertent relative movement therebetween. In other words, the housing and the mesh wall structure are precluded from substantial relative movement.

In some configurations, the mesh coupling structure further includes a downward slot extending axially around the depending wall portion. The downward slot is configured to receive the upper end of the mesh wall structure, so as to preclude further movement thereof toward the proximal end of the depending wall portion.

In some configurations, the downward slot is positioned so that the mesh wall structure extends to a location that is proximate an emitter retaining end of the elongated slot. Such a configuration facilitates the retention of the emitter hose within the elongated slot retaining end and the upper end of the mesh wall structure.

In some configurations, the downward slot is substantially continuous around the mesh wall structure, other than the elongated slot.

In some configurations, the downward slot is substantially parallel to the top panel portion. In such a configuration, the depending wall portion is substantially perpendicular thereto.

In some configurations, the top panel portion includes an inner portion that is defined by the depending wall portion, and an outer flange extending outside of the depending wall portion.

In some configurations, the top panel portion is substantially circular. Additionally, the depending wall portion is substantially cylindrical. The circular top portion defines a center with the depending wall portion defining an axis which extends through the center of the top portion such that the top portion an the depending wall portion are concentric.

In some configurations, the emitter opening is spaced apart from the axis and the center of the top portion toward the inner surface of the depending wall portion.

In some configurations, the top surface further includes a plurality of drainage openings spaced apart from the emitter access opening.

In some configurations, the depending wall portion includes a plurality of reinforcing beams extending along the inner surface thereof from the proximal end to the distal end thereof.

### BRIEF DESCRIPTION OF THE DRAWINGS

The disclosure will now be described with reference to the drawings wherein:

FIG. 1 of the drawings is a perspective view of the root nutrient delivery system of the present disclosure;

FIG. 2 of the drawings is a cross-sectional view of the root nutrient delivery system of the present disclosure, taken generally about lines 2-2 of FIG. 1;

FIG. 3 of the drawings is a perspective view of the housing of the root nutrient delivery system of the present disclosure;

FIG. 4 of the drawings is a front elevational view of the housing of the root nutrient delivery system of the present disclosure;

FIG. 5 of the drawings is a bottom perspective view of the housing of the root nutrient delivery system of the present disclosure;

FIG. 6 of the drawings is a cross-sectional view of the housing of the root nutrient delivery system of the present disclosure, taken generally about lines 6-6 of FIG. 4;

FIG. 7 of the drawings is a partial cross-sectional view of the nutrient delivery system of the present disclosure, taken generally about lines 7-7 of FIG. 1;

FIG. 8 of the drawings is a partial cross-sectional view of the nutrient delivery system of the present disclosure, taken generally about lines 2-2 of FIG. 1;

FIG. 9 of the drawings is a perspective view of the emitter assembly of the nutrient delivery system of the present disclosure; and

FIG. 10 of the drawings is another embodiment of the housing of the root nutrient delivery system of the present disclosure.

### DETAILED DESCRIPTION OF THE DISCLOSURE

While this invention is susceptible of embodiment in many different forms, there is shown in the drawings and described herein in detail a specific embodiment with the understanding that the present disclosure is to be considered as an exemplification and is not intended to be limited to the embodiment illustrated

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

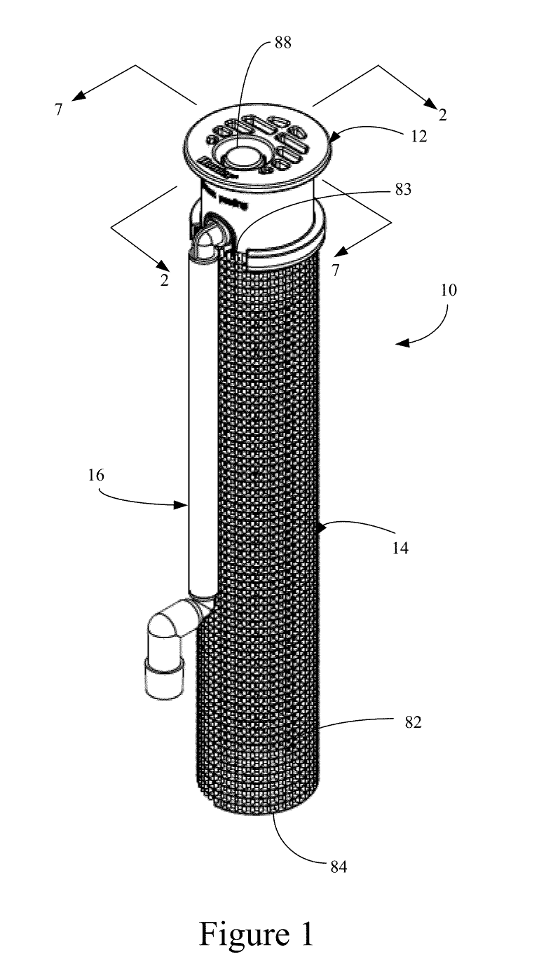

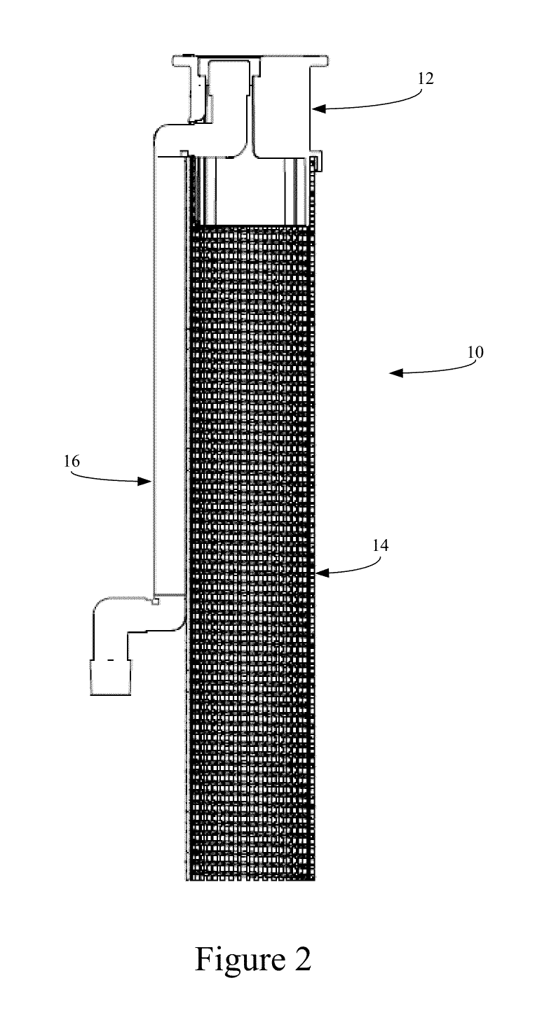

Referring now to the drawings and in particular to FIGS. 1 and 2, the root nutrient delivery system is shown generally at 10. It will be understood that such a system is configured for the receipt of an emitter or the like which is coupled to a fluid source (water or water combined with nutrients, for example). The system is configured to provide resources to the roots of a plant. The system is not limited to use in association with any particular type of plant, any environment, with a predetermined number of like systems or the like. The root nutrient delivery system may be incorporated into an overall irrigation system, or may be part of a nutrient system for an entire location.

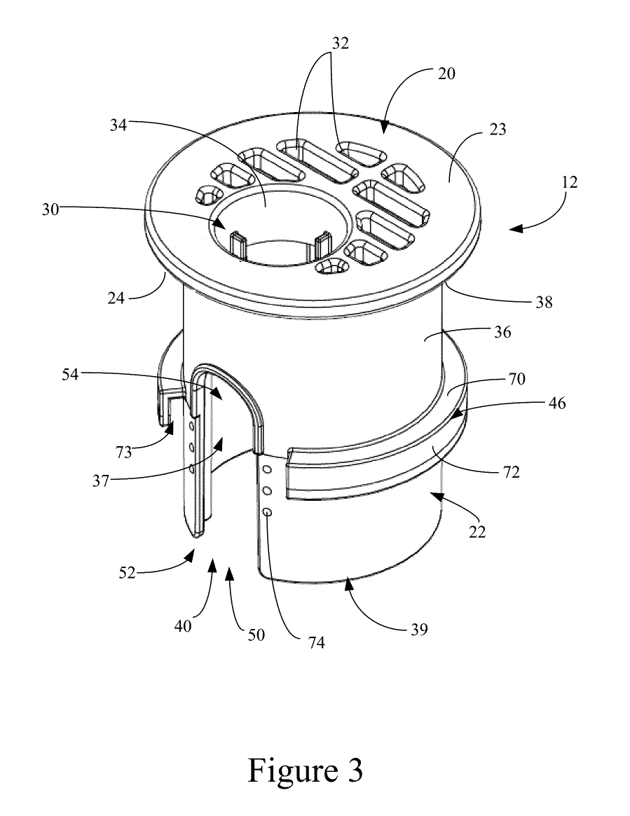

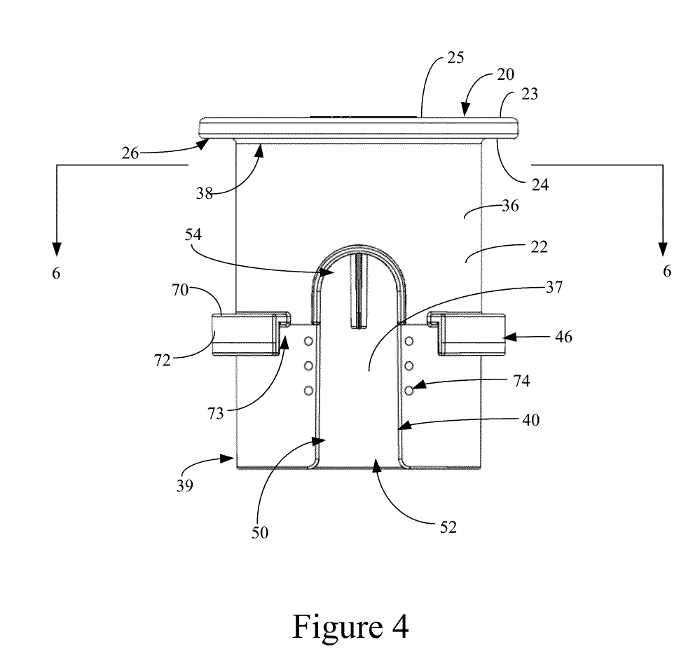

With continued reference to FIGS. 1 and 2, the system is shown as comprising housing 12 and mesh 14 to which emitter assembly is associatable and functionally coupled, and to which an emitter assembly 16 is coupled. With reference to FIGS. 3 and 4, the housing 12 comprises top panel portion 20 and depending wall portion 22. In the configuration shown, the housing 12 comprises an integrally formed and monolithic molded member (preferably molded from a polymer, or a fiber reinforced polymer). Of course, the configuration is not limited to an integrally molded member, or to a polymer based member. In other configurations, the top panel portion, or parts thereof, may be molded or formed separately from the depending wall portion. The depending wall portion may be formed from multiple members as well.

The top panel portion includes upper surface 23 and lower surface 24. An inner portion 25 extends within the perimeter of the depending wall portion 22, with the outer portion forming the outer flange outside of the perimeter of the depending wall portion 22. While variations are contemplated the top panel portion is substantially uniform in thickness. In addition, the top panel portion, it is contemplated is substantially planar, and substantially perpendicular to the depending wall portion. It will be understood that the top wall portion may have different shapes, such as convex or concave configurations and the like. It will also be understood that the top wall portion may be oblique to the depending wall portion, or may include different structures that are positioned at different angles relative to the depending wall portion.

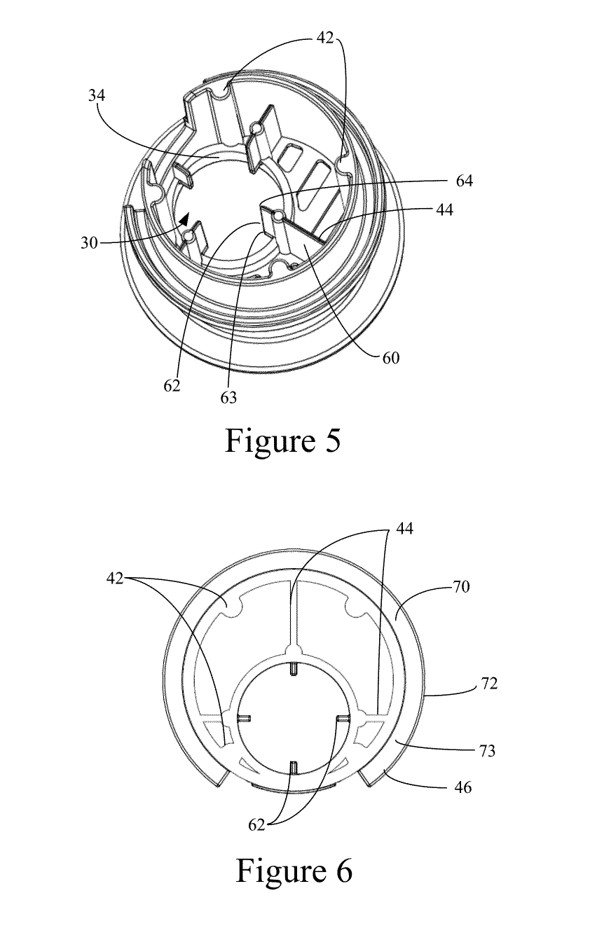

With reference to FIGS. 3 through 6, an emitter access opening 30 is defined into the inner portion 25 of the top panel portion. The access opening generally comprises a substantially circular opening with a depending wall portion extending from the lower surface 24. The depending wall portion is preferably a cylindrical member. In the configuration shown, the depending wall portion includes a cylindrical member having a first larger upper diameter and a second smaller lower diameter. The two are joined by an axial wall. In other configurations, the depending wall portion may comprise a uniform surface, or a surface that is varied. In the configuration shown, the opening is circular, however, other configurations, such as square, polygonal, arbitrary, random, as well as others are contemplated for use.

In the configuration shown, the top panel portion comprises a circular member defining a center. The emitter opening is spaced apart from the center of the top panel portion such that it is generally closer to the depending wall portion 22 and offset from the center of the top panel. It will be understood that in other embodiments, the top panel portion may comprise a shape other than circular, that is, square, polygonal, arbitrary or random, as well as specialized shapes to mimic specific structures (i.e., logos, drawings, map outlines and the like). It is also contemplated that the emitter access opening may be positioned at any desired location on the top panel structure.

A plurality of drainage openings, such as openings 32 are disposed about the top panel portion 20 spaced apart from the emitter access opening. In the configuration shown, the drainage openings 32 comprise a plurality of elongated openings that are positioned substantially parallel to each other in a spaced apart fashion, and extending about the emitter opening. Of course, the position and size of the drainage openings can be varied within the scope of the present disclosure.

With continued reference to FIGS. 3 through 6, the depending wall portion 22 is shown as comprising outer surface 36, inner surface 37, and extends from proximal end 38 to distal end 39. The depending wall portion, in the configuration shown comprises a generally elongated tubular member, such as a cylindrical member that depends from the lower surface 24 of the top panel portion 20. The generally cylindrical member has a substantially uniform diameter. In other embodiments, the depending wall may be other than a cylindrical member, and may be other than substantially uniform in cross-sectional configuration. For example, the depending wall may be frustoconical or may include a widened portion between the proximal and distal end.

The depending wall includes a plurality of structures that extend from, formed into, or that otherwise are coupled, at least in part thereto, including, emitter coupling structure 40, reinforcing beams, such as reinforcing beam 42, emitter reinforcing ribs 44 and mesh coupling structures 46. The emitter coupling structure 40 includes elongated slot 50 that is formed into the depending wall portion 22. The elongated slot 50 extends from the distal end 39 of the depending wall portion toward the proximal end. In the configuration shown, the elongated slot 50 extends to approximately a point that is midway between the proximal end 38 and the distal end 39. In the configuration shown, the elongated slot 50 is substantially perpendicular to the top panel portion 20. The elongated slot is defined by the entry end 52 at the distal end of the depending wall portion and emitter retaining end 54 opposite thereof. As will be explained in such a configuration, the mesh along with the configuration of the slot maintains the emitter assembly in the proper orientation.

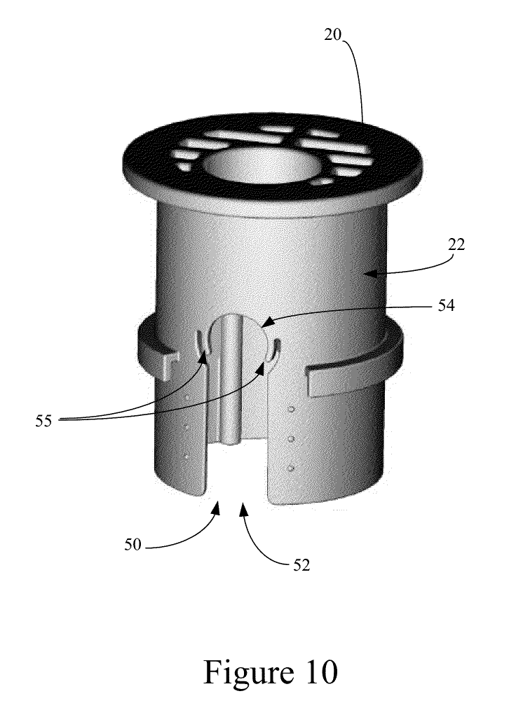

In the configuration of FIG. 10, the emitter retaining end 54 includes opposing locking fingers 55 that protrude inwardly into the elongated slot. The opposing locking fingers 55 can be elastically deformed to allow for the passage of the emitter hose therebeyond. Upon passage therebeyond, the emitter hose is captured by the retaining end 54 of the elongated slot 50 and the opposing locking fingers 55, and generally precluded from movement thereagainst.

With returning reference to FIGS. 3 through 6, in the configuration shown, the reinforcing beams 42 are spaced apart from each other and extend from the proximal end 38 to the distal end 39 of the depending wall portion 22. The reinforcing beams comprise elongated structures with generally semi-circular cross-sectional configurations that are equally spaced about the depending wall portion. In the configuration shown, four equally spaced reinforcing beams extend generally parallel to each other and generally perpendicular to the top panel portion. The reinforcing beams provide additional strength and integrity to the housing precluding collapse or bending of the depending wall portion.

The emitter reinforcing ribs 44 extend from the inner surface 37 of the depending wall portion 22 and from the lower surface 24 of the top panel portion terminating with an inner support surface, such as inner support surface 62 extending about the emitter access opening 30. In the configuration shown, the inner support surface 62 extends to match the position of the depending wall portion and extends between the lower end of the depending wall portion and the distal end of the depending wall portion. In the configuration shown, a total of four emitter reinforcing ribs 44 are disclosed spaced apart equidistantly from each other and extending radially from the depending wall portion to the inner surface of the depending wall portion, and downwardly from the lower surface of the top panel portion. The inner support surfaces 62 each include a top end 63 and a bottom end 64. The inner support surfaces provide additional support to maintain the emitter in the desired orientation (which is generally parallel to the inner support surface and generally vertical within the housing). In other configurations, a greater or fewer number of ribs may be presented. While in the configuration shown, the ribs may extend beyond the depending wall portion of the emitter access opening and into the footprint of the emitter access opening, it is contemplated that they may line up directly with the depending wall portion. Additionally, while the inner support surfaces are shown to be substantially vertical, other configurations, including inclined surfaces and the like are contemplated as well. In one configuration, the emitter reinforcing ribs 44 may be formed from the depending wall and may not extend to the inner surface 37. ApplicationAsFiled

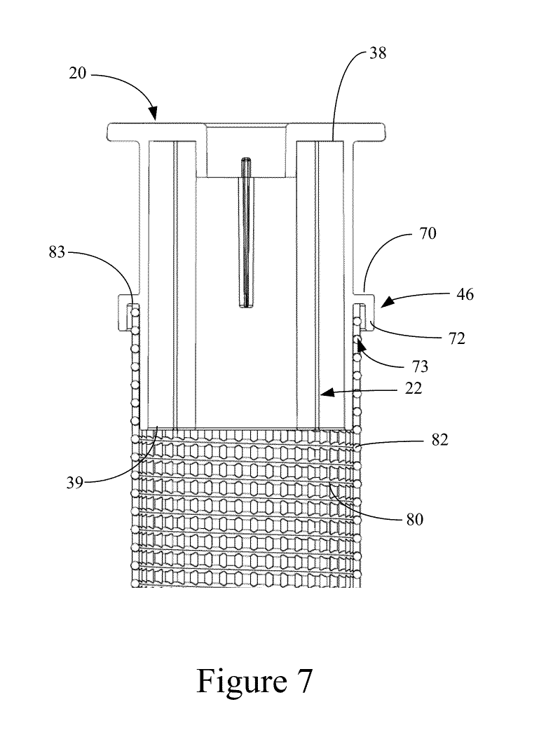

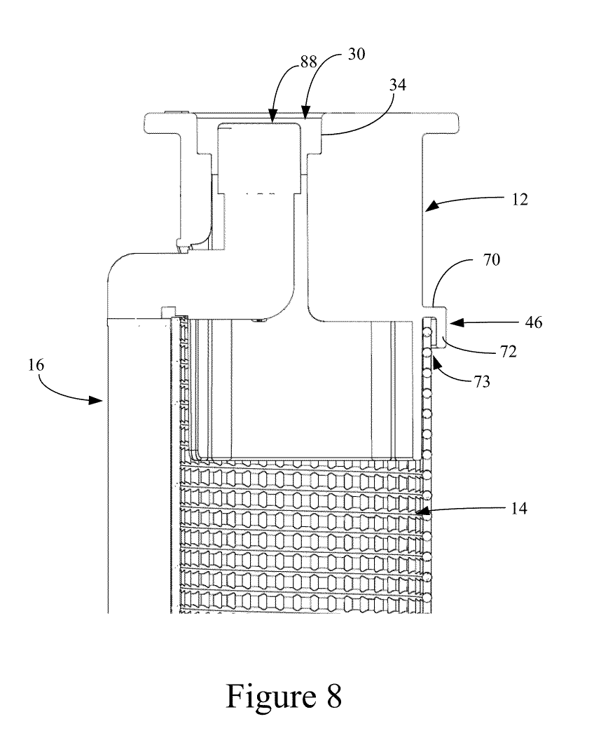

With reference to FIGS. 3, 4, 7 and 8, the mesh coupling structure 40 is shown as comprising downward slot 73 and retaining nubs 74. The downward slot is formed by axial wall 70 that extends axially outwardly from the depending wall portion and depending wall 72 which extends from the axial wall toward the distal end of the depending wall portion.

With reference to FIGS. 1, 2, 7 and 8, the mesh wall structure 14 is shown as comprising a substantially cylindrical formation of alternating vertical and horizontal members, wherein the horizontal member may comprise a helical winding which has a predominantly horizontal component. The mesh wall structure has substantially uniform openings formed by the vertical and helical/horizontal members. In the configuration shown, the alternating vertical and helical horizontal members create a plurality of voids, and in the configuration shown, substantially square voids (or slightly parallelogram in configuration). Of course, other configurations are contemplated, including, but not limited to differently shaped openings or voids, and, turn, other formations of the mesh wall structure. It will additionally be understood that the mesh wall structure may include a plurality of openings that are not uniform or that follow a pattern, but that are positioned at desired locations therealong. It is contemplated that the mesh wall structure may be longer than the housing. For example, the mesh wall structure may be between 6 inches and 42 inches in length, and more preferably between 12 inches and 36 inches, and most preferably between 18 and 36 inches while other configurations are contemplated which may be shorter or longer. The longer mesh portions facilitate the directing of nutrients and flowable material deeper into the ground.

The mesh wall structure includes an inner surface 80, an outer surface 82, and extends from an upper end 83 to a lower end 84. The mesh wall structure includes a substantially uniform cross-sectional configuration. It will be understood that in the operable configuration, the mesh wall structure is configured to slide over the outer surface of the depending wall portion 22 of the housing 12. The upper end 83 is configured to be directed into and reside within the downward slot 73 of the mesh coupling structure 46 on the outer surface of the depending wall portion. At the same time, the nubs interface with the voids between the alternating vertical and horizontal members so as to preclude relative movement of the two members.

It will be understood that in other configurations, the mesh wall structure may comprise a non-uniform configuration. That is, a configuration that includes surface variations, or that includes shape variations. For example, a narrowing portion may be positioned to correspond to the distal end of the depending wall portion when installed thereover. In other embodiments, the lower end of the mesh wall structure may include a conical configuration or a narrowing, or widening configuration.

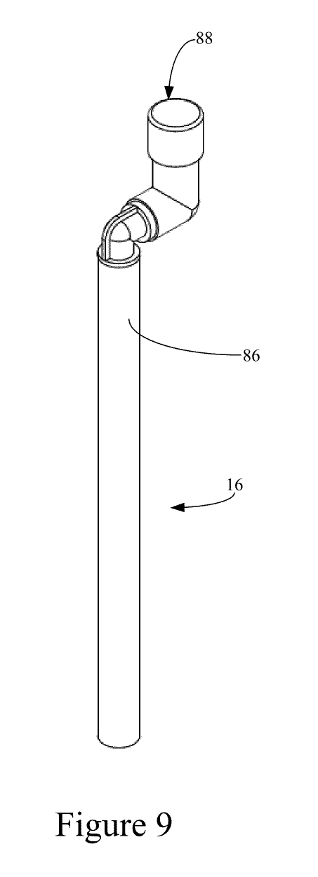

With reference to FIGS. 1, 2 and 9, the emitter assembly comprises a plurality of hoses that are coupled together through a plurality of junctions, with an emitter at the distal end thereof. The emitter may comprise a bubbler, or another structure which is configured to allow the passage of a predetermined amount of fluid from within the hose, when the hose is pressurized with fluid. In certain configurations, the emitter may comprise a permeable membrane with small openings that allow for the passage of a predetermined amount of fluid. In other configurations, the openings may allow for fluid to exit at a predetermined volume and velocity.

In other configurations, the emitter, the joints and the hoses may be formed from a single integrally molded member. This member may be coupled to an existing line through joints and connections outside and spaced apart from the housing and the mesh wall structure.

To prepare the assembly for attachment to a service line providing fluid, the housing is first provided. Once the housing 12 is provided, the user can couple the emitter assembly 16. That is, the emitter assembly is directed into the elongated slot of the emitter coupling structure 40. Eventually, the emitter assembly is directed to the emitter retaining end. In the embodiment of FIG. 10, due to the configuration and relative sizes thereof, as the emitter assembly is slid to contact the locking fingers 55, the locking fingers can be elastically deformed so as to allow the emitter to pass therebeyond. The emitter portion then extends into the emitter retaining end 52 of the elongated slot 50, and the locking fingers 55 return to sandwich the emitter between the locking fingers and the emitter retaining end. The structure allows for a snap fit operation (that is, positive feedback that the components have been joined together).

As the emitter is directed through the elongated slot 50, the user directs the emitter 88 into position within the depending wall portion 34 of the emitter access opening 30 of the housing 12. As set forth above, the depending wall portion, along with the inner support surfaces 62 of the emitter reinforcing ribs 44 assist with maintaining the emitter and the emitter assembly in the proper orientation (generally centered and vertical within the depending wall portion). Advantageously, the emitter 88 is generally sized so as to be smaller than the emitter access opening 30 so as to allow the grasping, manipulating and removing of the emitter from within the housing 12 upon installation through the emitter access opening. Portions of the emitter assembly may or may not co-act with the emitter reinforcing ribs.

Once the emitter is positioned and positioned into the desired configuration, the mesh wall structure can be introduced and coupled to the housing 12. In particular, the mesh wall structure is positioned so that the proximal end is directed to overlyingly engage the distal end of the depending wall portion. In the configuration shown, the structure of the two components is such that the mesh wall structure can extend, albeit snuggly, over the outer surface of the depending wall portion 22. The mesh wall structure is directed toward the proximal end of the depending wall portion (and as a sleeve over the depending wall portion).

Continued slidable engagement directs the mesh wall structure into the retaining nubs 74. The mesh wall structure, and the retaining nubs (and/or the housing) can elastically deform relative to each other to allow for slidable movement thereacross. Eventually, the upper end of the mesh wall structure engages the downward slot and is limited from further movement by the cooperative formation of the axial wall 70, the depending wall 72 and the outer surface of the depending wall portion 22. Between the nubs and the interference fit within the downward slot, the mesh is releasably retained in contact with the housing. At the same time, the position of the mesh coupling structure is such that the mesh wall structure stops short of the emitter hose within the elongated slot, but also performs the function of facilitating the retention thereof within the emitter retaining end of the elongated slot. In the configuration shown, the mesh wall structure extends approximately over half of the outside surface of the housing, by extending up to the downward slot. In the configuration shown, the downward slot is continuous (with the exception of the portion around the elongated slot) so as to provide a finish to the upper end of the mesh wall structure and to provide additional integrity thereto. Additionally, the mesh structure maintains the proper positioning of the emitter assembly within the elongated slot of the emitter coupling structure.

The system may be disassembled by grasping each of the mesh wall structure and the housing and pulling each in opposite directions. The upper end of the mesh wall structure can be released from the downward slot, and the mesh wall structure can be urged beyond the nubs that are positioned on the outer surface of the depending wall portion.

Once fully assembled, the system is ready for coupling to an existing hose and for insertion into operable position in the ground. It will be understood that the housing is typically buried into the ground so that the top panel portion is generally all that is seen and accessible to a user. In certain embodiments and configurations, a portion of the depending wall portion may be visible. In the event that the emitter requires adjustment, removal, or other action, access to the same can be achieved through the emitter access opening. Additionally, the emitter access opening provides an unobstructed view of the emitter, to form an inspection port. Further, the emitter access opening 30 is sized so that debris can extend through the opening and beyond the emitter to preclude water flow blockage. The emitter opening and the associated reinforcing ribs are configured to accept and retain a number of differently sized and shaped emitters so as to allow for a large variation as to the type and style of emitter utilized.

Any fluids that are directed toward the top panel portion can be drained into the cavity of the housing through the emitter access opening as well as the plurality of drainage openings.

The foregoing description merely explains and illustrates the invention and the invention is not limited thereto except insofar as the appended claims are so limited, as those skilled in the art who have the disclosure before them will be able to make modifications without departing from the scope of the invention.

What is claimed is:

1. A root nutrient delivery system comprising:
a housing having a top panel and a depending wall portion, the top panel including an upper surface and a lower surface, and, the depending wall portion defining an elongated tubular member extending from the lower surface to define a cavity, the top panel including an emitter access opening extending therethrough and in communication with the cavity defined by the depending wall portion, the depending wall portion including a proximal end proximate the top panel, and a distal end spaced apart therefrom;
a plurality of emitter reinforcing ribs extending from at least one of an inner surface of the depending wall portion and the lower surface of the top panel to a location proximate a projection of the emitter opening into the cavity, defining an inner support surface;
an elongated slot in the depending wall portion extending from the distal end thereof toward the proximal end thereof, the elongated slot configured to receive an emitter hose;
a mesh wall structure defining an elongated tubular member overlyingly positioned over at least a portion of an outer surface of the depending wall portion of the housing, the mesh wall structure slidably positioned over the distal end of the depending wall structure toward the proximal end of the depending wall structure, the mesh wall structure overlyingly positionable over at least a portion of the elongated slot defined in the depending wall portion;
wherein an emitter assembly may be inserted into the cavity through the elongated slot and captured therewithin with an emitter being positioned within a projection of the emitter access opening, surrounded by the emitter reinforcing ribs, with the emitter assembly including an emitter which is accessible through the emitter access opening.

2. The system of claim 1 wherein the emitter of the emitter assembly is smaller than the emitter access opening, and substantially free from contact with the inner support surface of the emitter reinforcing ribs.

3. The system of claim 2 wherein the emitter access opening further includes a depending wall portion directed into the cavity from the emitter access opening, with the inner support surfaces of the emitter reinforcing ribs extending therebelow.

4. The system of claim 1 wherein the elongated slot further includes an entry end proximate the distal end of the depending wall portion, and an emitter retaining end opposite thereof, and, a pair of opposing locking fingers which, together with the emitter retaining end are configured to sandwich an emitter hose therebetween.

5. The system of claim 4 wherein, the locking fingers are configured to be elastically deformed by an emitter hose slid along the elongated slot from the entry end to the emitter retaining end, and beyond the locking fingers.

6. The system of claim 1 wherein the mesh wall structure and the depending wall portion comprise substantially cylindrical members.

7. The system of claim 1 wherein the mesh wall structure comprises a plurality of alternating vertical and horizontal members defining substantially square voids therebetween.

8. The system of claim 1 further comprising a mesh coupling structure on the housing, the mesh coupling structure configured to releasably retain the mesh wall structure relative to the housing.

9. The system of claim 8 wherein the mesh coupling structure includes a plurality of nubs that extend from the outer surface of the depending wall portion and are configured to extend into a plurality of voids defined in the mesh wall structure, to preclude inadvertent relative movement therebetween.

10. The system of claim 9 wherein the mesh coupling structure further includes a downward slot extending axially around the depending wall portion, the downward slot configured to receive the upper end of the mesh wall structure, so as to preclude further movement thereof toward the proximal end of the depending wall portion.

11. The system of claim 10 wherein the downward slot is positioned so that the mesh wall structure extends to a location that is proximate an emitter retaining end of the elongated slot, so as to facilitate the retention of the emitter hose within the elongated slot retaining end and the upper end of the mesh wall structure.

12. The system of claim 11 wherein the downward slot is substantially continuous around the mesh wall structure, other than the elongated slot.

13. The system of claim 11 wherein the downward slot is substantially parallel to the top panel portion, with the depending wall portion being substantially perpendicular thereto.

14. The system of claim 1 wherein the top panel portion includes an inner portion that is defined by the depending wall portion, and an outer flange extending outside of the depending wall portion.

15. The system of claim 1 wherein the top panel portion is substantially circular, with the depending wall portion being substantially cylindrical, the circular top portion defining a center with the depending wall portion defining an axis which extends through the center of the top portion such that the top portion an the depending wall portion are concentric.

16. The system of claim 15, wherein the emitter opening is spaced apart from the axis and the center of the top portion toward the inner surface of the depending wall portion.

17. The system of claim 16 wherein the top surface further includes a plurality of drainage openings spaced apart from the emitter access opening.

18. The system of claim 1 wherein the depending wall portion includes a plurality of reinforcing beams extending along the inner surface thereof from the proximal end to the distal end thereof.
